(19) United States
(12) Patent Application Publication
(10) Pub. No.: US 2024/0315228 A1
(43) Pub. Date: Sep. 26, 2024

(54) MULTI-LAYERED GLUE BOARD FOR INSECT TRAP

(71) Applicant: GARDNER MANUFACTURING CO., INC., Horicon, WI (US)

(72) Inventors: Bruce R. Studer, Germantown, WI (US); Timothy M. Jones, Phoenix, AZ (US)

(21) Appl. No.: 18/124,448

(22) Filed: Mar. 21, 2023

(51) Int. Cl. A01M 1/16; C09J 7/40

(52) U.S. Cl. CPC A01M 1/16; C09J 7/403

(57) ABSTRACT

Supply and maintenance costs related to insect traps is reduced through the use of multi-layered glue boards adapted to provide a new layer of adhesive that can be exposed for use when an old layer becomes dry or coated with insects.

### CROSS-REFERENCED TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### I. Field of the Invention

The present invention relates to insect traps. More specifically, the present invention relates to glue boards for such traps.

### II. Related Art

Insect traps have been used for many years in restaurants, other food preparation facilities, and other building where the control of insects is deemed appropriate. An example of such a trap is shown in U.S. Pat. No. 4,876,822 granted Oct. 31, 1989, to James N. White and entitled “Flying Insect Control Unit Using Lights and Adhesives”. As shown in this patent, which is hereby incorporated in its entirety by reference, such traps typically include a housing containing an ultraviolet light source as an insect attractant and an adhesive on a substrate to which insects adhere when they touch the adhesive. The housing includes one or more openings to permit egress of ultraviolet light from the trap and the ingress of insects into the trap. The walls of the trap are typically adapted to direct the ultraviolet light away from the eyes of, for example, restaurant patrons in the room where the trap is located and shield from the patron's view the insects adhered to the glue board. The term “glue board” is typically used in the pest control industry to describe the combination of the substrate and adhesive.

Glue boards have proven to be an effective insect capture device, particularly when used in combination with an effective insect attractant. However, existing glue boards must routinely be replaced because they become ineffective over time. This occurs because the adhesive dries or becomes coated with dust and insects. The need to periodically replace glue boards increases the time and expense incurred by pest control companies and others that use such traps.

Efforts have been made to address these problems in the past by providing an insect capture mechanism comprising a pair of rollers, a motor, and a timing circuit. A roll of fly paper is placed on one of the rollers and the other roller, rotated by the motor, serves as a take-up roller. The timing circuit turns the motor on and off periodically to move a predetermined length of fly paper from the supply roller to an insect capture zone and later to the take-up roller. See, for example, U.S. Patent Publication No. 2017/0086448 A1 dated Mar. 30, 2017, entitled “Flying Insect Trap with Roller Advance.” Such mechanisms work well. However, retrofitting traps with such a mechanism is expensive. Such mechanisms add significantly to the overall cost of new traps.

### SUMMARY OF THE INVENTION

The present invention solves each of the foregoing problems by providing novel glue board arrangements. More specifically, glue boards made in accordance with the present invention comprise a stack including a primary substrate and a plurality of secondary substrates. The primary substrate, and each of the plurality of secondary substrates, has a top side and a bottom side. The top side of each such substrate includes a center section permanently coated with an adhesive. The bottom side of each of the plurality of secondary substrates is adapted to be releasably secured to the adhesive. As such, the stack is held together by the adhesive until sufficient force is applied to separate the top secondary substrate from the substrate immediately below and expose the adhesive on the top side of that substrate. Periodically, the layers are peeled away to ensure a fresh and clean layer of adhesive is available for the capture of insects landing or crawling on the exposed adhesive.

The primary substrate will typically be made of a stiff material. The top side of at least the primary substrate may also include non-sticky edge portions bounding the center section. This allows one to grip the glue board when peeling away an upper layer of the stack without touching the adhesive. Similar non-sticky portions may be provided on the top side of each of the plurality of secondary substrates for this same reason. Non-sticky tabs may also be secured to or provided as a part of the substrates to assist when removing the top layer from the stack.

The bottom side of each of the secondary substrates are adapted to permit the secondary substrate of each layer to release from the adhesive of the layer below. In some embodiments of the invention, this is achieved by providing the bottom surface comprising a plurality of narrow ridges and wide valleys. In such embodiments, the adhesive only engages to ridges and not the valleys permitting such release. Alternatively, or additionally, each of the plurality of second substrates may be a laminate including a lower substrate layer and an upper substrate layer. The lower substrate layer is made of a material adapted to releasably adhere to the adhesive while the upper substrate layer is made of a material to which the adhesive permanently adheres. For example, the lower substrate layer may be made of a material comprising a plasticizer. While a plasticizer is a substance (typically a solvent) added to a synthetic resin to produce or promote plasticity and flexibility and to reduce brittleness, another characteristic of plasticizers is that they often reduce the adherence of an adhesive to a material including a plasticizer.

Similarly, the adhesive may be selected or adapted so that it permanently bonds to the top of the substrates but releasably bonds to the bottom of a secondary substrate. For example, discontinuous microsphere adhesives work well when the secondary substrates are laminates having a top layer made of a paper and a bottom layer made of a plastic or a plastic-coated paper.

### BRIEF DESCRIPTION OF THE DRAWINGS

The foregoing features, objects and advantages of the invention will become apparent to those skilled in the art from the following detailed description and with reference to the following drawings in which like numerals in the several views refer to corresponding parts.

FIG. 1 is a perspective view of a multi-layered glue board made in accordance with the present invention.

FIG. 2 is a side view of the glue board of FIG. 1.

FIG. 3 is an exploded view showing a multi-layered glue board comprising three layers.

FIG. 4 is a bottom view of a secondary substrate that may be used in the assembly of a multi-layered glue board.

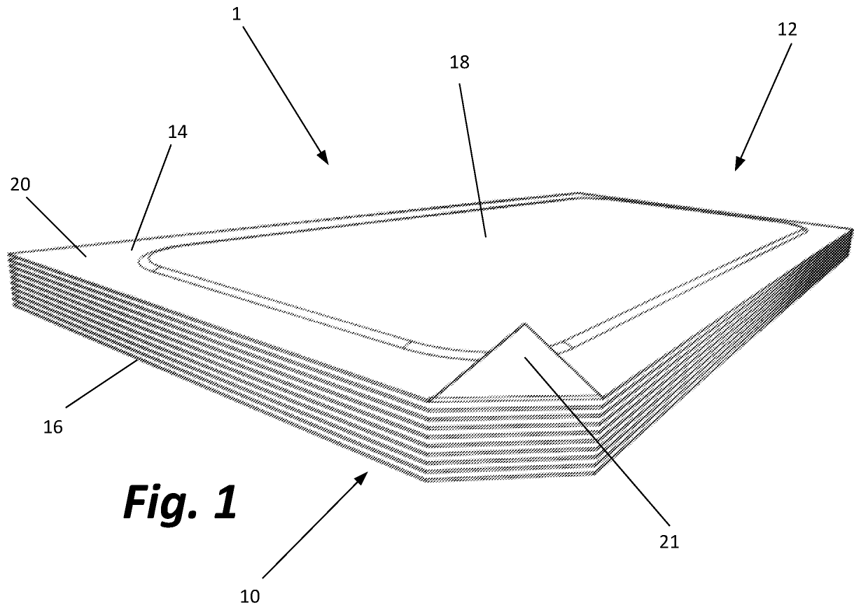

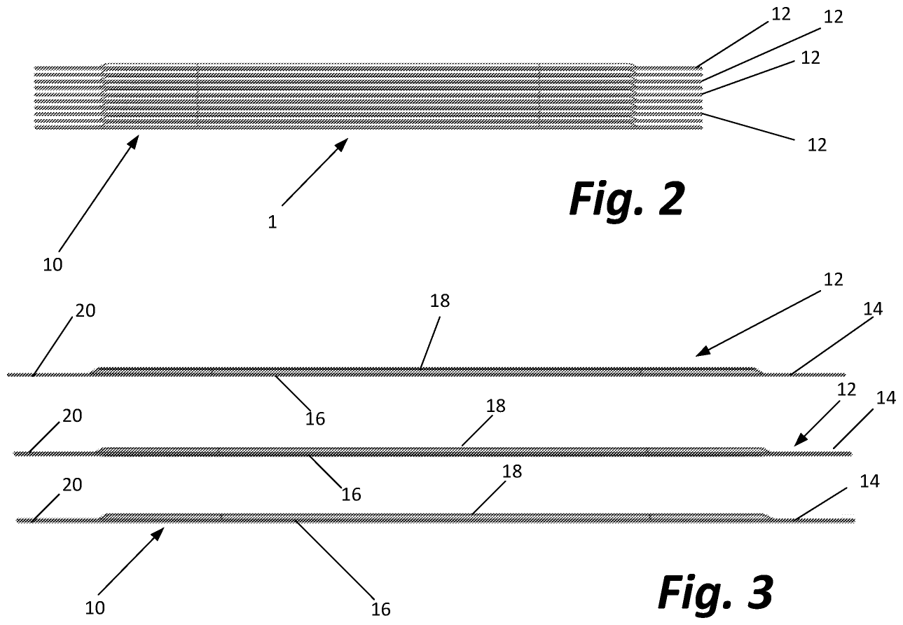

### DETAILED DESCRIPTION

This description of the preferred embodiment is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom”, “under”, as well as derivatives thereof (e.g., “horizontally”, “downwardly”, “upwardly”, “underside”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “joined”, and “joining” are used interchangeably and refer to one structure or surface being secured to another structure or surface or integrally fabricated in one piece unless expressly described otherwise.

Multi-layered glue boards 1 made in accordance with the present invention are shown in the drawings. Glue boards 1 include a stack comprising a primary substrate 10 and a plurality of secondary substrates 12. The primary substrate 10, and each of said plurality of secondary substrates 12, has a top side 14 and a bottom side 16. The top side 14 of the primary substrate 10 and each of the secondary substrates 12 includes a center section 18 permanently coated with an adhesive. The bottom side 16 of each of the plurality of secondary substrates 12 is adapted to be releasably secured to the adhesive. As such, the stack is held together by the adhesive until sufficient force is applied to separate the top secondary substrate 12 from the substrate immediately below and expose the adhesive on the top side 14 of that substrate. Periodically, the layers of the stack are peeled away in this fashion to ensure a fresh and clean layer of adhesive is available for the capture of insects landing or crawling on the exposed adhesive.

The primary substrate 10 will typically be made of a stiff material. The top side 14 of the primary substrate and each of the plurality of secondary substrates 12 may also include non-sticky edge portions 20 bounding the center section. This allows one to grip the glue board when peeling away an upper layer of the stack without touching the adhesive. Non-sticky tabs 21 may also be secured to (or provided as a part of) the substrates 10/12 for this purpose.

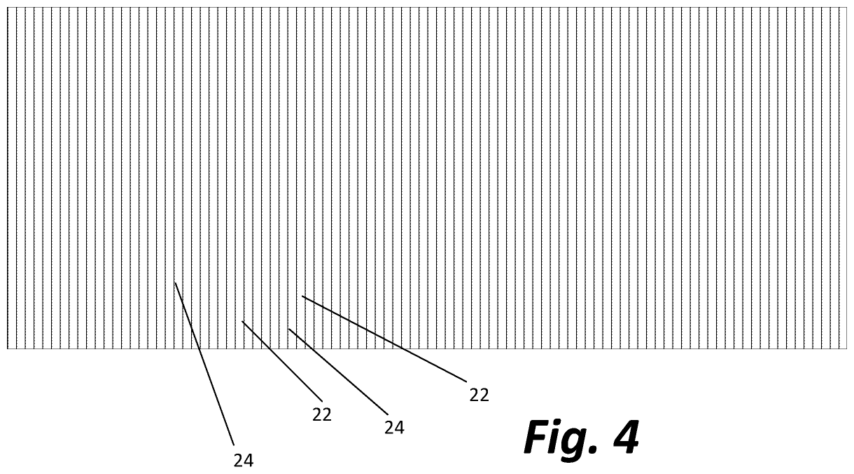

The bottom side 16 of each of the secondary substrates 12 is adapted to permit the secondary substrate of each layer to release from the adhesive of the layer below. In some embodiments of the invention, this is achieved by providing a bottom surface comprising a plurality of narrow ridges 22 and wider valleys 24 as shown in FIG. 4. In such embodiments, the adhesive only engages the ridges 22 and not the valleys 24 permitting such release. Alternatively, or additionally, each of the plurality of secondary substrates 12 may be a laminate including a lower substrate layer and an upper substrate layer. The lower substrate layer is made of a material adapted to releasably adhere to the adhesive while the upper substrate layer is made of a material to which the adhesive permanently adheres. For example, the lower substrate layer may be made of a material comprising a plasticizer. While a plasticizer is a substance (typically a solvent) added to a synthetic resin to produce or promote plasticity and flexibility and to reduce brittleness, another characteristic of plasticizers is that they often reduce the adherence of an adhesive to a material including a plasticizer.

Similarly, the adhesive may be selected or adapted so that it permanently bonds to the top of the substrates but releasably bonds to the bottom of a secondary substrate. For example, discontinuous microsphere adhesives work well when the secondary substrates are laminates having a top layer made of a paper and a bottom layer made of a plastic or a plastic-coated paper.

Within the scope of the following claims, the invention may be practiced otherwise than as specifically shown in the drawings and described above. The foregoing description is intended to explain the various features and advantages but is not intended to be limiting. The scope of the invention is defined by the following claims which are also intended to cover a reasonable range of equivalents.

1. A trap glue board comprising:
a. a primary substrate having a top side and a bottom side, said top side having a first center section, said first center section coated with a first adhesive layer;
b. a second substrate comprising a bottom surface and a top surface, said bottom surface adapted to be releasably secured to the primary substrate by the first adhesive layer, and said top surface having a second center section coated with a second adhesive layer.

2. The trap glue board of claim 1 further comprising a third substrate comprising a lower surface and an upper surface, said lower surface adapted to be releasably secured to the second substrate by the second adhesive layer, and said upper surface having a third center section coated with a third adhesive layer.

3. The trap glue board of claim 1 wherein said primary substrate is made of a stiff material.

4. The trap glue board of claim 1 wherein said top side further comprises non-sticky edge portions bounding the center section.

5. The trap glue board of claim 1 wherein said bottom surface of said second substrate includes a plurality of ridges and valleys.

6. The trap glue board of claim 1 wherein said second substrate comprises a laminate including a lower substrate layer and an upper substrate layer.

7. The trap glue board of claim 6 wherein said lower substrate layer is made of a material adapted to releasably adhere to the first adhesive layer, and said upper substrate layer is made of a material to which the second adhesive layer permanently adheres.

8. The trap glue board of claim 7 wherein said lower substrate layer is made of a material comprising a plasticizer.

9. The trap glue board of claim 1 wherein said first adhesive layer comprised a discontinuous microsphere adhesive.

10. The trap glue board of claim 1 wherein said second substrate further comprises a non-sticky tab.

11. A trap glue board comprising a stack including a primary substrate and a plurality of secondary substrates, said primary substrate and each of said plurality of secondary substrates having a top side and a bottom side, wherein said top side of said primary substrate and each of said plurality of secondary substrates comprises a center section permanently coated with an adhesive, and wherein the bottom side of each of said plurality of secondary substrates is adapted to be releasably secured to the adhesive.

12. The trap glue board of claim 11 wherein said primary substrate is made of a stiff material.

13. The trap glue board of claim 11 wherein said top side of at least the primary substrate further comprises non-sticky edge portions bounding the center section.

14. The trap glue board of claim 11 wherein said bottom side of each of said second substrates includes a bottom surface comprising a plurality of ridges and valleys.

15. The trap glue board of claim 11 wherein said each of said plurality of second substrates comprises a laminate including a lower substrate layer and an upper substrate layer.

16. The trap glue board of claim 15 wherein said lower substrate layer is made of a material adapted to releasably adhere to the adhesive and said upper substrate layer is made of a material to which the adhesive permanently adheres.

17. The trap glue board of claim 16 wherein said lower substrate layer is made of a material comprising a plasticizer.

18. The trap glue board of claim 11 wherein said adhesive is a discontinuous microsphere adhesive.

19. The trap glue board of claim 11 wherein each of said plurality of secondary substrates further comprises a non-sticky tab.
